(19) United States
(12) Patent Application Publication
(10) Pub. No.: US 2009/0002248 A1
(43) Pub. Date: Jan. 1, 2009

(54) Half-and Quarter-Wavelength Printed Slot Ultra-Wideband (Uwb) Antennas for Mobile Terminals

(76) Inventors: Anping Zhao, Espoo (FI); Jussi Rahola, Espoo (FI)

Correspondence Address: HARRINGTON & SMITH, PC, 4 RESEARCH DRIVE, Suite 202, SHELTON, CT, 06484-6212, US

(21) Appl. No.: 11/664,848

(22) PCT Filed: Oct. 13, 2004
(86) PCT No.: PCT/IB04/03343

§ 371 Date: Apr. 5, 2007

(51) Int. Cl. H01Q 13/10; H01Q 1/38; H01Q 1/00

(52) U.S. Cl. 343/722; 343/767; 343/700 MS

(57) ABSTRACT

The present invention employs slot antennas to make UWB antenna and a quarter-wavelength slot UWB antenna for use in mobile terminals. The slot length, which is related to the lower resonant frequency, is about half (for the half-wavelength slot antenna) or quarter (for the quarter-wavelength slot antenna) of the wavelength, while the higher resonant frequency is related to a dimension of the tuning stub. By modifying the dimensions of the tuning stub, good impedance matching of the antenna can be achieved according to the desired operating frequency. This invention can be used for mobile terminals to transmit and receive UWB signals in the frequency range of 3.1 GHz-4.9 GHz.

### TECHNICAL FIELD

This invention generally concerns antennas and, more specifically, concerns half- and quarter-wavelength printed slot ultra-wideband (“UWB”) antennas for use in mobile terminals.

### BACKGROUND

Wireless multimedia systems are becoming increasingly popular. However, improvements are still needed in order to provide higher-data-rate communication links, for example, to efficiently transmit video signals. As a result, more attention is being directed to the development of ultra-wideband (“UWB”) communication systems. The UWB communication system is a short-range wireless technology, which is expected to play a role in scenarios where “everybody and everything” is connected by different types of communication links including human to human, human to machine, machine to human, and machine to machine. It is anticipated that the consumer electronics and personal computer industries soon will take advantage of UWB technology to transmit data, video and audio. This technology will also provide a clear added-value benefit to the mobile phone industry by developing UWB-equipped mobile devices.

In order to transmit and receive UWB signals, an effective UWB antenna is required. In the past, although different types of UWB antennas (such as, for example, 3-D cone and 2-D planar bow-tie antennas) have been proposed, these antennas have CONFIRMATION COPY not been suitable for mobile terminals as the size of these proposed UWB antennas is quite large. In fact, for a successful design of an UWB antenna, special requirements, such as compactness, low profile, and low cost, need to be met. This invention provides a suitable solution to meet the needs of mobile terminals.

Prior art examples of proposed UWB antenna designs for mobile terminals include “Novel Microstrip-Monopole-Integrated Ultra-Wideband Antenna for Mobile UWB Devices,” by Y. J. Wang, C. K. Lee, P. S. Tian, and S. W. Lee, 2003 Radio and Wireless Conference Proceedings, pp. 87-90. This design utilizes a microstrip-monopole integrated UWB antenna. In this design, however, the physical dimension of the UWB antenna is 40 mm×40 mm×15.5 mm, which is too large for modern mobile handsets. Other examples have utilized a printed slot antenna for wideband [Jia-Yi Sze, and Kin-Lu Wong, “Bandwidth Enhancement of a Microstrip-Line-Fed Printed Wide-Slot Antenna,” IEEE Transactions on Antennas and Propagations, vol. 49, No. 7, pp. 1020-1024, July 2001] and ultra-wideband [X. Qing, M. Y. W. Chia, X. Wu, “Wide-Slot Antenna for UWB Applications,” IEEE 2003 Antennas and Propagation Society International Symposium, vol. 1, pp. 834-837] operations. It is to be noted, however, that the size of the printed circuit board (“PCB”) used in the designs of the printed slot antenna for wideband and ultra-wideband operations were not related to the size of any actual mobile terminals, hence these designs cannot be directly used for mobile handsets. Additionally, the size of conventional slot antennas is based on half-wavelength designs.

### SUMMARY OF THE PREFERRED EMBODIMENTS

The foregoing and other problems are overcome, and other advantages are realized, in accordance with the presently preferred embodiments of these teachings.

The present invention employs slot antennas integrated on a printed circuit board to make UWB antennas for mobile terminals. The slot antennas integrated on a PCB of a mobile terminal can be used as a UWB antenna.

An embodiment of the present invention employs a slot antenna to form an UWB antenna for a mobile terminal, including a half-wavelength slot UWB antenna and a quarter-wavelength slot UWB antenna. Embodiments in accordance with this invention can be used for mobile terminals to transmit and receive UWB signals in the frequency range of, for example, 3.0 GHz to 5.0 GHz.

A first alternate embodiment of the present invention comprises a half-wavelength slot antenna comprising: a dielectric substrate having a first side and a second side; an electrically conducting layer positioned on the first side of the dielectric substrate, wherein there is a rectangular slot in the electrically conducting layer exposing a portion of the first side of the dielectric substrate, and wherein the rectangular slot has at least a first side and a second side orthogonal to the first side; a feed line positioned on the second side of the dielectric substrate, wherein a centerline of the feed line extends parallel to the first side of the rectangular slot and wherein the feed line has proximal and distal ends, the distal end of the feed line extending just into a region on the second side of the dielectric substrate directly opposite the rectangular slot, bisecting the second side of the rectangular slot; a fork-shaped tuning stub positioned on the second side of the dielectric substrate directly opposite the rectangular slot of the first side, the fork-shaped tuning stub comprising a first branch extending transversely in either direction from the distal end of the feed line parallel to the second side of the rectangular slot, wherein the first branch has an intermediate point and two distal ends, the intermediate point of the first branch aligning with the distal end of the feed line, the fork-shaped tuning stub further comprising second branches extending transversely from the distal ends of the first branch parallel to the first side of the rectangular slot; and wherein the first side of the rectangular slot is about 10 mm and the second side of the rectangular slot is about 28 mm; the first branch has a length of about 18 mm, and wherein the half-wavelength antenna operates in the frequency range of about 3.1 GHz to 4.9 GHz.

In one variant of the first alternate embodiment, the half-wavelength antenna comprises a half-wavelength slot ultra wideband antenna.

In another variant of the first alternate embodiment, the feed line of the half-wavelength antenna comprises a microstrip line.

In a further variant of the first alternate embodiment, the return loss of the half-wavelength antenna has at least two resonant frequencies within the operating frequency range.

In yet another variant of the first alternate embodiment, the first resonant frequency is a function of the length of the second side of the slot, and the second resonant frequency is a function of the length of the first branch of the fork-shaped tuning stub of the half-wavelength antenna.

In a still further variant of the first alternate embodiment the invention comprises an antenna assembly, wherein the antenna assembly comprises: a half-wavelength slot antenna comprising: a dielectric substrate having a first side and a second side; an electrically conducting layer positioned on the first side of the dielectric substrate, wherein there is a rectangular slot in the electrically conducting layer exposing a portion of the first side of the dielectric substrate, and wherein the rectangular slot has at least a first side and a second side orthogonal to the first side; a feed line positioned on the second side of the dielectric substrate, wherein a centerline of the feed line extends parallel to the first side of the rectangular slot and wherein the feed line has proximal and distal ends, the distal end of the feed line extending just into a region on the second side of the dielectric substrate directly opposite the rectangular slot, bisecting the second side of the rectangular slot; a fork-shaped tuning stub positioned on the second side of the dielectric substrate directly opposite the rectangular slot of the first side, the fork-shaped tuning stub comprising a first branch extending transversely in either direction from the distal end of the feed line parallel to the second side of the rectangular slot, wherein the first branch has an intermediate point and two distal ends, the intermediate point of the first branch aligning with the distal end of the feed line, the fork-shaped tuning stub further comprising second branches extending transversely from the distal ends of the first branch parallel to the first side of the rectangular slot; and wherein the antenna assembly further comprises: a dual-band planar inverted F-antenna positioned on the dielectric substrate.

By employing slot antennas printed on a PCB of a mobile terminal, slot UWB antennas suitable for mobile terminals can be designed. Additionally, to further reduce the size of the printed slot UWB antennas, quarter-wavelength slot UWB antennas are utilized.

By using quarter-wavelength printed slot antennas, a size savings of at least 80% can be achieved in comparison to conventional half-wavelength slot antennas, while retaining desirable resonant and radiation properties. In addition, interactions between the printed slot ultra-wideband antennas and the dual-band planar inverted F-Antenna (PIFA) antennas used in mobile terminals for cellular radio systems (e.g. GSM, cdma2000, WCDMA) are substantially reduced. The isolation between the slot and PIFA antennas is low enough so that both antennas can be used in the same terminal.

Thus, a second alternate embodiment of the present invention comprises a quarter-wavelength slot antenna comprising: a dielectric substrate having a first side, a second side and at least one edge; an electrically conducting layer positioned on the first side of the dielectric substrate, wherein there is a rectangular slot in the electrically conducting layer exposing a portion of the first side of the dielectric substrate, and wherein a first side of the rectangular slot is aligned with the at least one edge of the dielectric substrate; a feed line positioned on the second side of the dielectric substrate, wherein a centerline of the feed line extends parallel to the first side of the rectangular slot and wherein the feed line extends along the at least one edge of the dielectric substrate, and wherein the feed line has proximal and distal ends, the distal end of the feed line extending just into a region on the second side of the dielectric substrate directly opposite the rectangular slot; and an L-shaped tuning stub positioned on the second side of the dielectric substrate directly opposite the rectangular slot of the first side, the L-shaped tuning stub comprising a first branch extending transversely from the distal end of the feed line away from the first edge of the dielectric substrate parallel to a second side of the rectangular slot, wherein the first branch has proximal and distal ends, the L-shaped tuning stub further comprising a second branch extending transversely from the distal end of the first branch parallel to the first side of the rectangular slot.

In one variant of the second alternate embodiment of the present invention, the feed line comprises a microstrip line.

In another variant of the second alternate embodiment of the present invention, the antenna operates in the frequency range of about 3.1 GHz to 4.9 GHz.

In a further embodiment of the second alternate embodiment of the present invention, the return loss of the quarter-wavelength antenna has at least two resonant frequencies within the operating frequency range.

In yet another embodiment of the second alternate embodiment of the present invention, the at least two resonant frequencies comprise a first resonant frequency, wherein the first resonant frequency is a function of the length of the second side of the rectangular slot; and a second resonant frequency, wherein the second resonant frequency is a function of the length of the first branch of the L-shaped tuning stub.

In a still further variant of the second alternate embodiment the invention comprises an antenna assembly, wherein the antenna assembly comprises a quarter-wavelength slot antenna comprising: a dielectric substrate having a first side, a second side and at least two edges, wherein the two edges comprise a first edge and a second edge orthogonal to the first edge; an electrically conducting layer positioned on the first side of the dielectric substrate, wherein there is a rectangular slot in the electrically conducting layer exposing a portion of the first side of the dielectric substrate, and wherein a first side of the rectangular slot is aligned with the first edge of the dielectric substrate; a feed line positioned on the second side of the dielectric substrate, wherein a centerline of the feed line extends parallel to the first side of the rectangular slot and wherein the feed line extends along the at least one edge of the dielectric substrate, and wherein the feed line has proximal and distal ends, the distal end of the feed line extending just into a region of second side of the dielectric substrate directly opposite the rectangular slot; an L-shaped tuning stub positioned on the second side of the dielectric substrate directly opposite the rectangular slot of the first side, the L-shaped tuning stub comprising a first branch extending transversely from the distal end of the feed line away from the first edge of the dielectric substrate parallel to a second side of the rectangular slot, wherein the first branch has proximal and distal ends, the L-shaped tuning stub further comprising a second branch extending transversely from the distal end of the first branch parallel to the first side of the rectangular slot; and a dual-band planar inverted F-antenna positioned on the dielectric substrate inward from the second edge of the dielectric substrate.

A third alternate embodiment of the present invention comprises a mobile station having an antenna assembly, wherein the antenna assembly comprises a half-wavelength slot antenna comprising: a dielectric substrate having a first side and a second side; an electrically conducting layer positioned on the first side of the dielectric substrate, wherein there is a rectangular slot in the electrically conducting layer exposing a portion of the first side of the dielectric substrate, and wherein the rectangular slot has at least a first side and a second side orthogonal to the first side; a feed line positioned on the second side of the dielectric substrate, wherein a centerline of the feed line extends parallel to the first side of the rectangular slot and wherein the feed line has proximal and distal ends, the distal end of the feed line extending just into a region on the second side of the dielectric substrate directly opposite the rectangular slot, bisecting the second side of the rectangular slot; a fork-shaped tuning stub positioned on the second side of the dielectric substrate directly opposite the rectangular slot of the first side, the fork-shaped tuning stub comprising a first branch extending transversely in either direction from the distal end of the feed line parallel to the second side of the rectangular slot, wherein the first branch has an intermediate point and two distal ends, the intermediate point of the first branch aligning with the distal end of the feed line, the fork-shaped tuning stub further comprising second branches extending transversely from the distal end of the first branch parallel to the first side of the rectangular slot; and wherein the first side of the rectangular slot is about 10 mm and the second side of the rectangular slot is about 28 mm; the first branch has a length of about 18 mm, and wherein the half-wavelength antenna operates in the frequency range of about 3.1 GHz to 4.9 GHz.

In one variant of the mobile station of the third alternate embodiment, the antenna assembly further comprises a dual-band planar inverted F-antenna.

A fourth alternate embodiment of the present invention comprises a mobile station having an antenna assembly, wherein the antenna assembly comprises: a quarter-wavelength slot antenna comprising: a dielectric substrate having a first side, a second side and at least one edge; an electrically conducting layer positioned on the first side of the dielectric substrate, wherein there is a rectangular slot in the electrically conducting layer exposing a portion of the first side of the dielectric substrate, and wherein a first side of the rectangular slot is aligned with the at least one edge of the dielectric substrate; a feed line positioned on the second side of the dielectric substrate, wherein a centerline of the feed line extends parallel to the first side of the rectangular slot and wherein the feed line extends along the at least one edge of the dielectric substrate, and wherein the feed line has proximal and distal ends, the distal end of the feed line extending just into a region on the second side of the dielectric substrate directly opposite the rectangular slot; and an L-shaped tuning stub positioned on the second side of the dielectric substrate directly opposite the rectangular slot of the first side, the L-shaped tuning stub comprising a first branch extending transversely from the distal end of the feed line away from the first edge of the dielectric substrate parallel to a second side of the rectangular slot, wherein the first branch has proximal and distal ends, the L-shaped tuning stub further comprising a second branch extending transversely from the distal end of the first branch parallel to the first side of the rectangular slot.

In one variant of the mobile station of the fourth alternate embodiment, the quarter-wavelength slot antenna operates in the frequency range of about 3.1 GHz to 4.9 GHz.

In another variant of the mobile station of the fourth alternate embodiment, the antenna assembly further comprises a dual-band planar inverted F-antenna.

In conclusion, printed UWB slot antennas made in accordance with the present invention have at least the following advantages: they are thin, being the thickness of the PCB only; they are resistant to breakage; and they require no special fabrication steps and are therefore inexpensive to manufacture.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIGS. 1A and 1B depict a top view and an edge-on views of a half-wavelength slot UWB antenna integrated on a PCB of a mobile terminal, made in accordance with a first alternate embodiment of this invention;

FIG. 2 is a graph of the return loss of the half-wavelength UWB slot antenna of FIGS. 1A and 1B;

FIG. 3 is a top view of a quarter-wavelength slot UWB antenna integrated on a PCB of a mobile terminal according to three non-limiting variants of a second alternate embodiment of the present invention;

FIG. 4 is an edge-on view of a quarter-wavelength slot UWB antenna integrated on a PCB of a mobile terminal according to three non-limiting variants of a second alternate embodiment of the present invention;

FIG. 5 is a graph showing the return loss of the three quarter-wavelength slot UWB antennas integrated on the PCB of FIGS. 3 and 4;

FIG. 6A depicts a top view of an antenna assembly comprising a dual-band planar inverted F-Antenna (PIFA) antenna and a half-wavelength slot UWB antenna made in accordance with a variant of the first alternate embodiment of the present invention and FIG. 6B shows the return loss of the dual-band PIFA antenna (S11) and the half-wavelength slot UWB antenna (S22), and the isolation between them (S21);

FIG. 7A depicts a top view of an antenna assembly comprising a dual-band planar inverted F-Antenna (PIFA) antenna and a quarter-wavelength slot UWB antenna made in accordance with a variant of the second alternate embodiment of the present invention and FIG. 7B shows the return loss of the dual-band PIFA antenna (S11) and the quarter-wavelength slot UWB antenna (S22), and the isolation between them (S21);

FIG. 8A depicts a top view of an antenna assembly comprising a dual-band planar inverted F-Antenna (PIFA) antenna and a quarter-wavelength slot UWB antenna made in accordance with a variant of the second alternate embodiment of the present invention and FIG. 8B shows the return loss of the dual-band PIFA antenna (S11) and the quarter-wavelength slot UWB antenna (S22), and the isolation between them (S21); and

FIG. 9 depicts a top view of an antenna assembly comprising a dual-band planar inverted F-Antenna (PIFA) antenna and a quarter-wavelength slot UWB antenna made in accordance with a variant of the second alternate embodiment of the present invention and FIG. 9B shows the return loss of the dual-band PIFA antenna (S11) and the quarter-wavelength slot UWB antenna (S22), and the isolation between them (S21).

### DETAILED DESCRIPTION OF THE PREFERRED EMBODIMENTS

In a non-limiting embodiment of this invention, both half- and quarter-wavelength slot UWB antennas are integrated on a ground plane of length 80 mm, width 40 mm, and thickness 1 mm, which is the size of a typical PCB for a mobile terminal. The dielectric material used for the PCB is FR4 with τᵣ=4.4, and the electric conductivity of the metals is 4.9×10⁷. All of the antenna examples are simulated with IE3D (a commercial software package based on the method of moment). Moreover, the UWB antennas preferably operate in the frequency range of 3.1 GHz to 4.9 GHz, although this is not a limitation on the practice of the preferred embodiments of this invention.

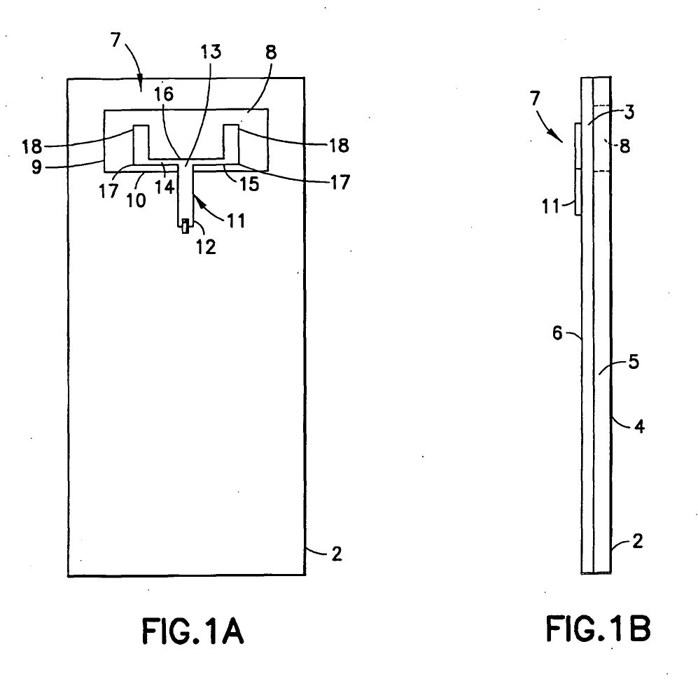

FIGS. 1A and 1B depict top and edge-on views of a half-wavelength printed slot UWB antenna 7 integrated on a PCB 2 made in accordance with a first alternate embodiment of the present invention. The half-wavelength printed slot UWB antenna is constructed as follows. The PCB 2 comprises, in part, dielectric material 3 in the region of the half-wavelength slot antenna 7. Positioned on a first side 4 of the PCB 2 is an electrically conducting layer 5. Located on the first side 4 of the PCB 2 is a rectangular slot 8. The rectangular slot 8 has at least a first side 9 and a second side 10 orthogonal to the first side 9 of the slot 8. Printed on a second side 6 of the PCB 2 is feed line 11. Feed line 11 has proximal 12 and distal 13 ends. Distal end 13 of feed line 11 extends just into a region on the second side 6 of the PCB 2 directly opposite the slot 8 and bisects the second side 10 of the slot 8. The centerline of the feed line 11 extends substantially parallel to the first side 9 of the rectangular slot 8. Also printed on the second side 6 of the PCB 2 is a fork-shaped tuning stub 14 comprising a first branch 15 and second branches 18. First branch 15 of the fork-shaped tuning stub 14 has an intermediate point 16 aligning with the distal end 13 of the feed line II and distal ends 17. Second branches 18 extend transversely from the distal ends 17 of the first branch 15. As was noted above, the dimensions of the PCB 2 is preferably 40 mm×80 mm×1 mm, and the size of the slot 8 is preferably 28 mm(l)×10 mm(w) to achieve an operating frequency within the range of 3.1 GHz to 4.9 GHz.

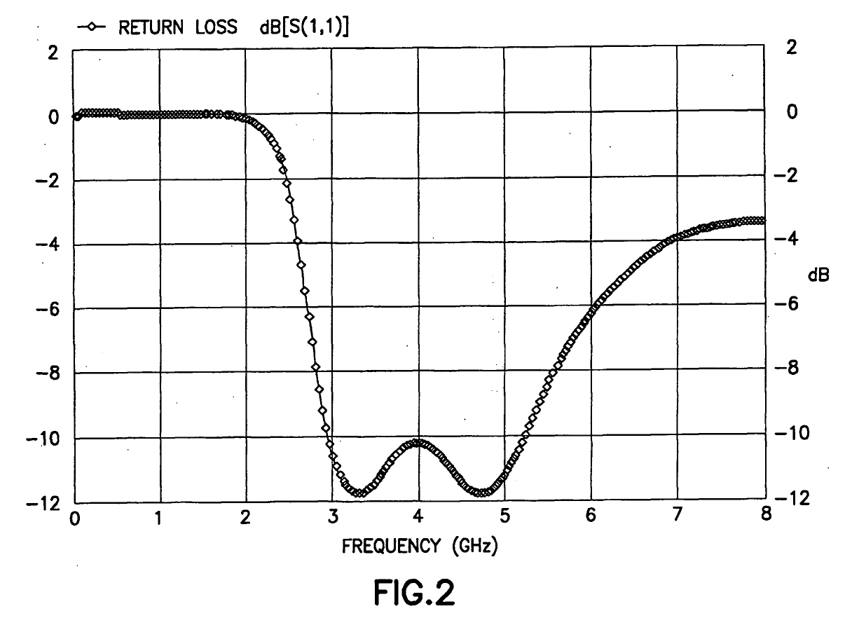

The return loss of the half-wavelength slot antenna 7 is shown in FIG. 2. From FIG. 2, it can be seen that the return loss of the antenna 7 is below 10 dB for frequencies between 2.9 GHz and 5.3 GHz. The good impedance matching of the slot antenna 7 across such a wideband is obtained by varying the dimensions of the tuning stub 14. For example, in one preferred, but non-limiting embodiment, the dimensions of the second branches 18 of tuning stub 14 are approximately 2 mm×5.5 mm. It can also be seen from FIG. 2 that the curve of the return loss has two resonant frequencies within the operating frequency range: one is at about 3.3 GHz and the other is at about 4.8 GHz. In fact, the lower resonant frequency is controlled by the length (28 mm) of the second side 10 of slot 8, and the higher resonant frequency is determined by the length (18 mm) of the first branch 15 of the fork-shaped tuning stub 14. The length of second side 10 of slot 8 is about one half-wavelength of the lower resonant frequency, and thus this slot antenna is referred to as a half-wavelength slot UWB antenna. By modifying the dimensions of the first branch 15 and second branches 18, good impedance matching of the antenna can be achieved according to the desired operating frequency.

The electric field component (E_{y}) within the half-wavelength slot antenna 7 is advantageously symmetrical with respect to the central line (along y-axis) of the slot. The E_{y} field has its maximum at the central line of the slot 8 and its minimum at the two ends of the slot 8. Therefore, the central line of the slot 8 is an H-wall or open circuit. This beneficial property of the half-wavelength slot antenna is an important principle for designing quarter-wavelength slot UWB antennas, as illustrated below.

### The Quarter-Wavelength Printed Slot UWB Antenna for Mobile Terminals

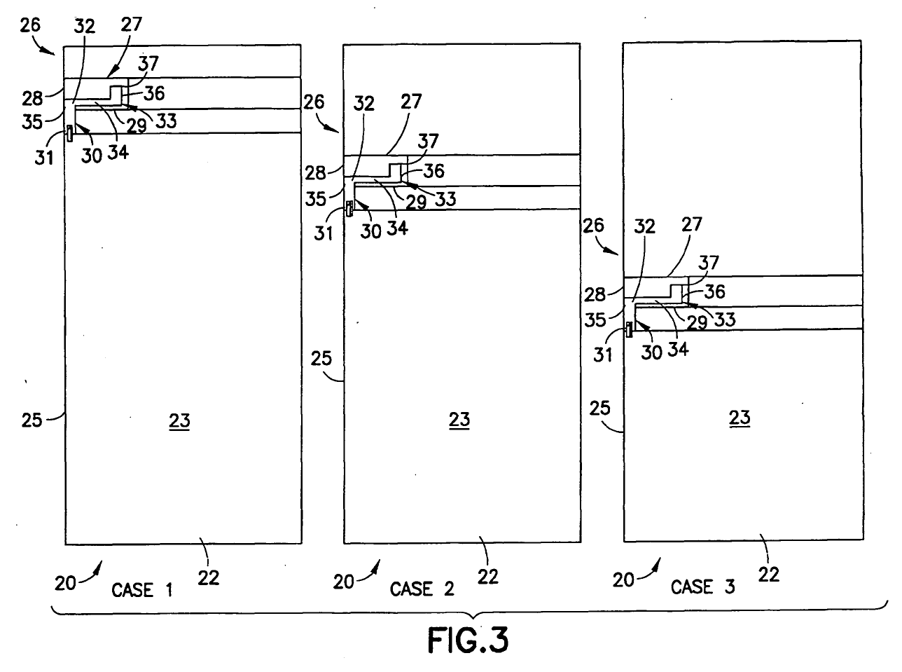

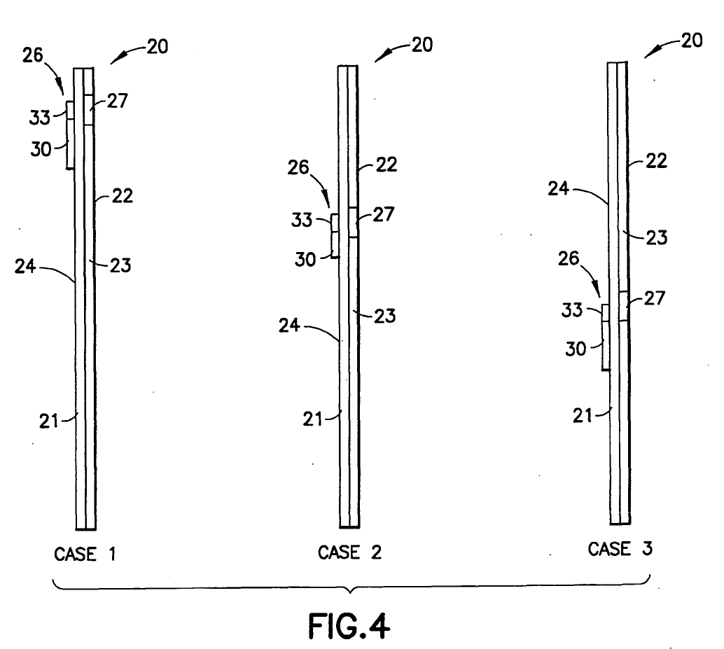

Because of the above-mentioned special property of half-wavelength slot antennas, quarter-wavelength slot UWB antennas can be designed by using half of the slot (where the slot is placed at one edge of the PCB). FIGS. 3 and 4 depict quarter-wavelength slot UWB antennas 26 made in accordance with a second alternate embodiment of the present invention located at three different positions along first edges 25 of PCBs 20. The construction of the quarter-wavelength slot antennas is as follows. The PCBs 20 comprise, in part, dielectric material 21 in the region of the quarter-wavelength slot antennas 26. Positioned on first sides 22 of the PCBs 20 are electrically conducting layers 23. Located along first edges 25 and on the first sides 22 of the PCBs 20 are rectangular slots 27. The rectangular slots 27 have at least a first side 28 that aligns with the first edge 25 of the PCB 20 and a second side 29 orthogonal to the first side 28 of the slot 27. Printed on second sides 24 of the PCBs 20 are feed lines 30. Feed lines 30 have proximal 31 and distal 32 ends. Distal ends 32 of feed lines 30 extend just into regions on the second sides 24 of the PCBs 20 directly opposite the slots 27. Centerlines of the feed lines 30 extend substantially parallel to the first sides 28 of the rectangular slots 27. Also printed on the second sides 24 of the PCBs 20 are L-shaped stubs 33 comprising first branches 34 and second branches 37. First branches 34 of the L-shaped stubs 33 have proximal 35 and distal 36 ends. First branches 34 extend transversely from distal ends 32 of feed lines 30 parallel to second sides 29 of the rectangular slots 27. Second branches 37 extend transversely from distal ends 36 of first branches 34. The antennas 26 are fed at a feed point which coincides with the proximal ends 31 of the feed lines 30. The dimension of the PCB 20 is preferably 40 mm×80 min×1 mm, whereas the size of the slot 27 and the first branch 34 of the L-shaped tuning stub 33 for cases 1, 2 and 3 are preferably (a) 12 mm×4 mm (slot 27), 10.2 mm×0.75 mm (first branch 34), (b) 11.8 mm×4 mm, 10.5 mm×0.75 mm, and (c) 12.75 mm×4 mm, 10.2 mm×0.75 mm, respectively. The dimensions for the second branch 37 of the L-shaped tuning stub 33 for cases 1, 2 and 3 are preferably (a) 1.5 mm×1.5 mm, (b) 1.5 mm×1.5 mm, and (c) 1.5 mm×1.75 mm, respectively.

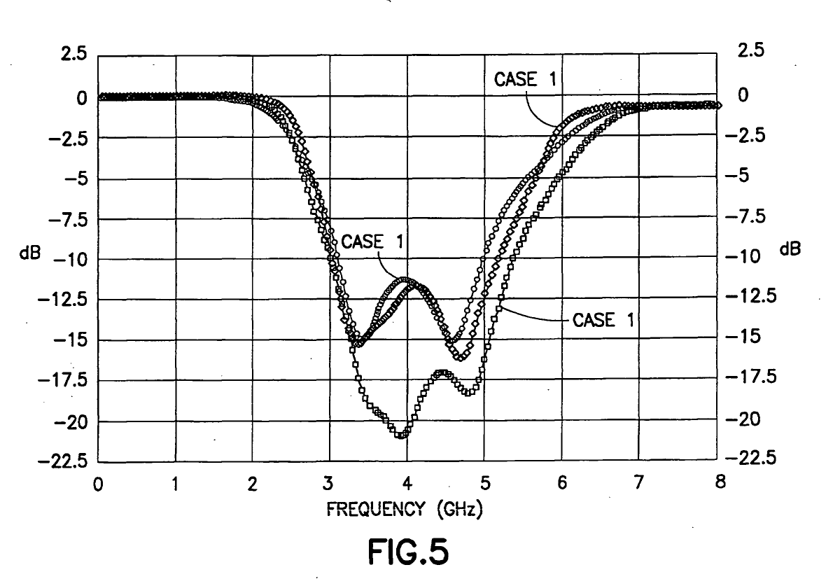

The return loss of the quarter-wavelength slot UWB antenna 26 located at three different positions (case 1, case 2, case 3) on the PCB 20 is illustrated in FIG. 5. From FIG. 5 it can be seen that, even though the dimensions of the quarter-wavelength slot UWB antenna are reduced by about 80% from the original size of the half-wavelength slot UWB antenna, the operating frequency of the quarter-wavelength slot UWB antenna is still in the range of about 3.1 GHz to 4.9 GHz. This is due at least in part to the stronger capacitive effects which occur at the open sides 28 of the quarter-wavelength slot UWB antennas 26. The quarter-wavelength slot UWB antenna 26 is therefore preferable for mobile terminals over the half-wavelength slot UWB antenna 7 due to the smaller size of the quarter-wavelength slot UWB antenna.

### The Isolation of the Half- and Quarter-Wavelength Printed Slot UWB Antenna and Dual-Band PIFA Antennas

Discussed now is the isolation between the half- and quarter-wavelength slot UWB antenna, and a conventional dual band PIFA GSM antenna (working at frequencies of 0.9 GHz and 1.8 GHz). In particular, the dual-band PIFA antenna is located 8 mm above the PCB.

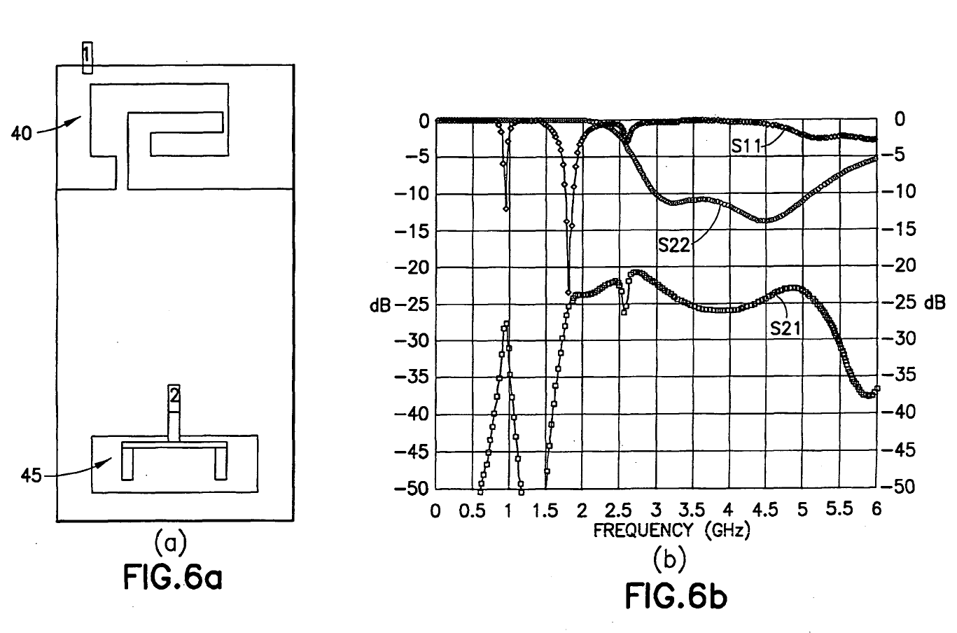

FIG. 6 (a) illustrates the locations of the dual-band PIFA antenna 40 (constructed on the top of the terminal) and the half-wavelength slot UWB antenna 45, whereas the return loss of the dual-band PIFA antenna (S11) and the half-wavelength slot UWB antenna (S22) and the isolation (indicated by S21) are shown in FIG. 6(b). From FIG. 6(b) it can be seen that the isolation between these two antennas is more than 20 dB, which is sufficient for practical purposes.

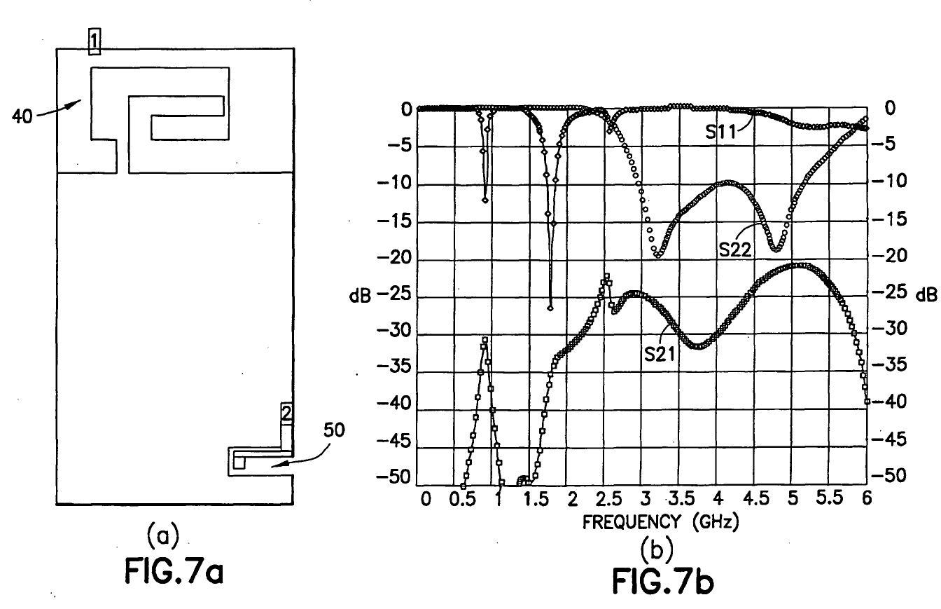

FIG. 7 illustrates the isolation of a dual-band PIFA antenna and the first quarter-wavelength slot UWB antenna. The locations of the dual-band PIFA antenna 40 and the quarter-wavelength slot UWB antenna 50 are shown in FIG. 7a, while the return loss of the dual-band PIFA antenna (S11), the quarter-wavelength slot UWB antenna (S22), and the isolation between them (S21) are shown in FIG. 7(b).

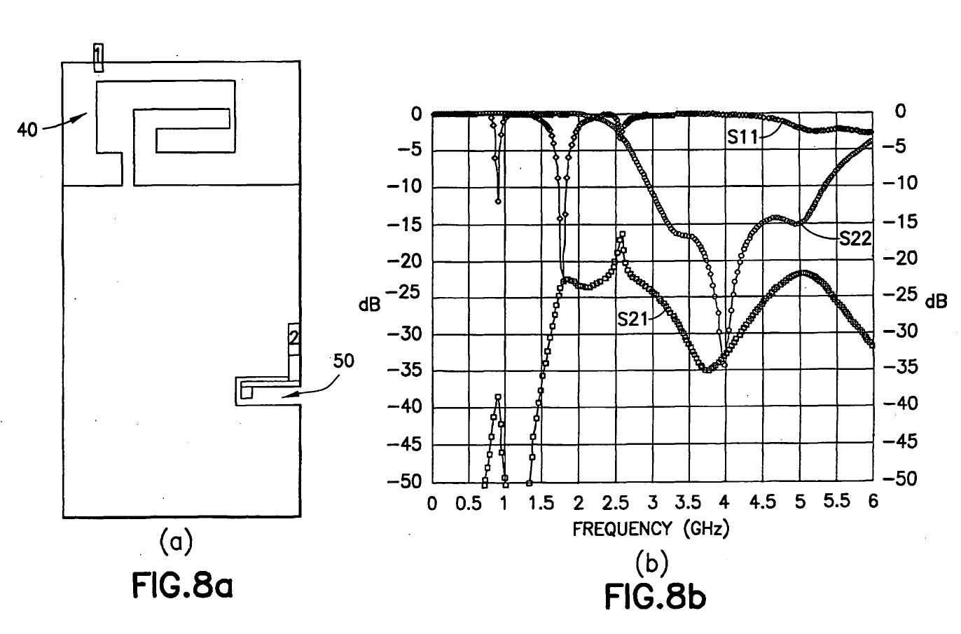

FIG. 8 illustrates the isolation of a dual-band PIFA antenna and the second quarter-wavelength slot UWB antenna. The locations of the dual-band PIFA antenna 40 and the quarter-wavelength slot UWB antenna 50 are shown in FIG. 8(a), while the return loss of the dual-band PIFA antenna (S11), the quarter-wavelength slot UWB antenna (S22), and the isolation between them (S21) are shown in FIG. 8(b).

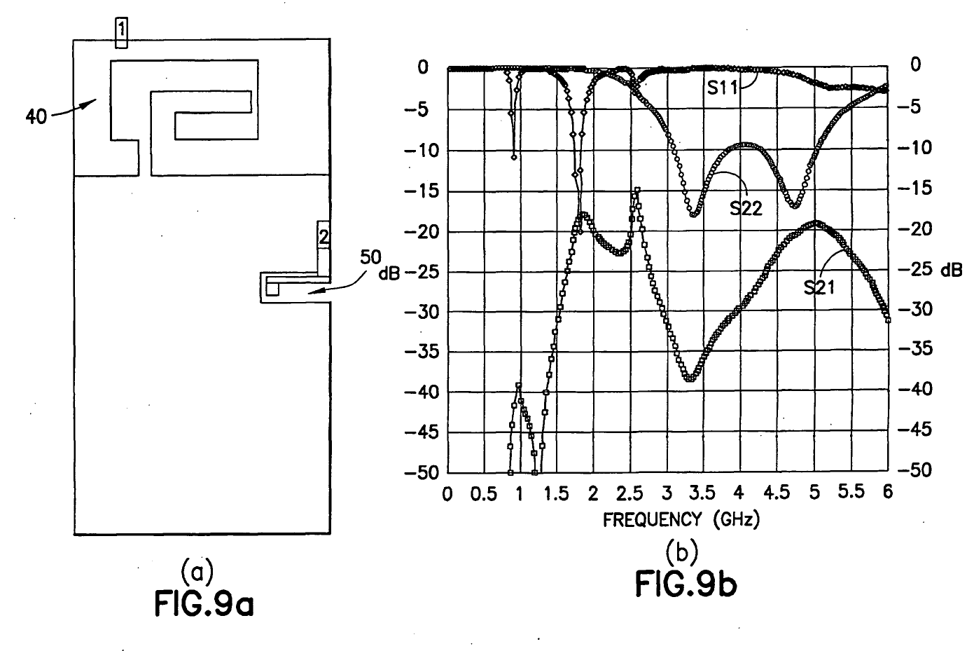

FIG. 9 illustrates the isolation of a dual-band PIFA antenna 40 and the third quarter-wavelength slot UWB antenna. The locations of the dual-band PIFA antenna 40 and the quarter-wavelength slot UWB antenna 50 are shown in FIG. 9(a), while the return loss of the dual-band PIFA antenna (S11), the quarter-wavelength slot UWB antenna (S22), and the isolation between them (S21) are shown in FIG. 9(b).

From these figures it can be seen that the isolation for each of the above quarter-wavelength slot UWB antenna examples is also sufficient. In addition, among the above three quarter-wavelength slot UWB antenna examples, the first quarter-wavelength slot UWB antenna of FIG. 7 presents the best isolation. This is due to the fact that in the first quarter-wavelength slot UWB antenna example the two antennas are separated by the greatest distance, and hence the best isolation occurs.

From the above analysis, it can be readily observed that from a compactness and low profile point of view, the quarter-wavelength slot UWB antenna is suitable for use in mobile terminals and other small-form-factor electronic devices.

An advantage of using the quarter-wavelength slot UWB antennas over the half-wavelength slot UWB antenna is the size reduction, which makes the quarter-wavelength slot UWB antenna more suitable for mobile terminals. The following conclusions can be made for the quarter-wavelength and half-wavelength slot UWB antennas:
Size: the size of the half-wavelength slot UWB antenna is 28 mm×10 mm, whereas the (largest) size of the quarter-wavelength slot UWB antenna is 12.75 mm×4 mm. Hence, compared with the half-wavelength slot UWB antenna, an approximately 80% size reduction can be achieved if the quarter-wavelength slot UWB antenna is used;
Radiation Pattern: the PCB dominates the radiation pattern in the application of mobile terminals, hence the half-wavelength and quarter-wavelength slot UWB antennas have a similar radiation pattern;
Radiation Efficiency: the minimum (occurred at the higher frequency) radiation frequency of the half-wavelength slot UWB antenna is about 75%, whereas for the quarter-wavelength slot UWB antenna it is about 65%. The reduction in radiation efficiency is due to the small dimension of the quarter-wavelength slot UWB antenna.

Additionally, the best isolation performance (between the dual-band PIFA antenna 40 and the quarter-wavelength slot UWB antennas 50) is obtained when the PIFA antenna 40 and the quarter-wavelength slot UWB antenna 50 have the greatest separation distance.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

What is claimed is:

1. A quarter-wavelength slot antenna comprising:
a dielectric substrate having a first side, a second side and at least one edge;
an electrically conducting layer positioned on the first side of the dielectric substrate, wherein there is a rectangular slot in the electrically conducting layer exposing a portion of the first side of the dielectric substrate, and wherein a first side of the rectangular slot is aligned with the at least one edge of the dielectric substrate;
a feed line positioned on the second side of the dielectric substrate, wherein a centerline of the feed line extends parallel to the first side of the rectangular slot and wherein the feed line extends along the at least one edge of the dielectric substrate, and wherein the feed line has proximal and distal ends, the distal end of the feed line extending just into a region on the second side of the dielectric substrate directly opposite the rectangular slot; and
an L-shaped tuning stub positioned on the second side of the dielectric substrate directly opposite the rectangular slot of the first side, the L-shaped tuning stub comprising a first branch extending transversely from the distal end of the feed line away from the first edge of the dielectric substrate parallel to a second side of the rectangular slot, wherein the first branch has proximal and distal ends, the L-shaped tuning stub further comprising a second branch extending transversely from the distal end of the first branch parallel to the first side of the rectangular slot.

2. The quarter-wavelength slot antenna of claim 1 wherein the feed line is a microstrip line.

3. The quarter-wavelength slot antenna of claim 1 wherein the antenna operates in the frequency range of about 3.1 GHz to 4.9 GHz.

4. The quarter-wavelength slot antenna of claim 1, wherein the return loss of the quarter-wavelength antenna has at least two resonant frequencies within the operating frequency range.

5. The quarter-wavelength slot antenna of claim 4, wherein the at least two resonant frequencies comprise a first resonant frequency, wherein the first resonant frequency is a function of the length of the second side of the rectangular slot; and a second resonant frequency, wherein the second resonant frequency is a function of the length of the first branch of the L-shaped tuning stub.

6. An antenna assembly for use in a mobile terminal comprising:
a quarter-wavelength slot antenna comprising:
a dielectric substrate having a first side, a second side and at least two edges, wherein the two edges comprise a first edge and a second edge orthogonal to the first edge;
an electrically conducting layer positioned on the first side of the dielectric substrate, wherein there is a rectangular slot in the electrically conducting layer exposing a portion of the first side of the dielectric substrate, and wherein a first side of the rectangular slot is aligned with the first edge of the dielectric substrate;
a feed line positioned on the second side of the dielectric substrate, wherein a centerline of the feed line extends parallel to the first side of the rectangular slot and wherein the feed line extends along the at least one edge of the dielectric substrate, and wherein the feed line has proximal and distal ends, the distal end of the feed line extending just into a region of second side of the dielectric substrate directly opposite the rectangular slot;
an L-shaped tuning stub positioned on the second side of the dielectric substrate directly opposite the rectangular slot of the first side, the L-shaped tuning stub comprising a first branch extending transversely from the distal end of the feed line away from the first edge of the dielectric substrate parallel to a second side of the rectangular slot, wherein the first branch has proximal and distal ends, the L-shaped tuning stub further comprising a second branch extending transversely from the distal end of the first branch parallel to the first side of the rectangular slot; and
a dual-band planar inverted F-antenna positioned on the dielectric substrate inward from the second edge of the dielectric substrate.

7. A half-wavelength slot antenna comprising:
a dielectric substrate having a first side and a second side;
an electrically conducting layer positioned on the first side of the dielectric substrate, wherein there is a rectangular slot in the electrically conducting layer exposing a portion of the first side of the dielectric substrate, and wherein the rectangular slot has at least a first side and a second side orthogonal to the first side;
a feed line positioned on the second side of the dielectric substrate, wherein a centerline of the feed line extends parallel to the first side of the rectangular slot and wherein the feed line has proximal and distal ends, the distal end of the feed line extending just into a region on the second side of the dielectric substrate directly opposite the rectangular slot, bisecting the second side of the rectangular slot;
a fork-shaped tuning stub positioned on the second side of the dielectric substrate directly opposite the rectangular slot of the first side, the fork-shaped tuning stub comprising a first branch extending transversely in either direction from the distal end of the feed line parallel to the second side of the rectangular slot, wherein the first branch has an intermediate point and two distal ends, the intermediate point of the first branch aligning with the distal end of the feed line, the fork-shaped tuning stub further comprising second branches extending transversely from the distals end of the first branch parallel to the first side of the rectangular slot; and wherein
the first side of the rectangular slot is about 10 mm and the second side of the rectangular slot is about 28 mm; the first branch has a length of about 18 mm, and wherein the half-wavelength antenna operates in the frequency range of about 3.1 GHz to 4.9 GHz.

8. An antenna as in claim 7, wherein the half-wavelength antenna comprises a half-wavelength slot ultra wideband antenna.

9. An antenna as in claim 7, wherein the feed line of the half-wavelength antenna is comprises a microstrip line.

10. An antenna as in claim 7, wherein the return loss of the half-wavelength antenna has at least two resonant frequencies within the operating frequency range.

11. An antenna as in claim 10, wherein the first resonant frequency is a function of the length of the second side of the slot, and the second resonant frequency is a function of the length of the first branch of the fork-shaped tuning stub of the half-wavelength antenna.

12. An antenna assembly for use in a mobile terminal, the antenna assembly comprising:
a half-wavelength slot antenna comprising:
a dielectric substrate having a first side and a second side;
an electrically conducting layer positioned on the first side of the dielectric substrate, wherein there is a rectangular slot in the electrically conducting layer exposing a portion of the first side of the dielectric substrate, and wherein the rectangular slot has at least a first side and a second side orthogonal to the first side;
a feed line positioned on the second side of the dielectric substrate, wherein a centerline of the feed line extends parallel to the first side of the rectangular slot and wherein the feed line has proximal and distal ends, the distal end of the feed line extending just into a region on the second side of the dielectric substrate directly opposite the rectangular slot, bisecting the second side of the rectangular slot;
a fork-shaped tuning stub positioned on the second side of the dielectric substrate directly opposite the rectangular slot of the first side, the fork-shaped tuning stub comprising a first branch extending transversely in either direction from the distal end of the feed line parallel to the second side of the rectangular slot, wherein the first branch has an intermediate point and two distal ends, the intermediate point of the first branch aligning with the distal end of the feed line, the fork-shaped tuning stub further comprising second branches extending transversely from the distal ends of the first branch parallel to the first side of the rectangular slot; and wherein the antenna assembly further comprises:
a dual-band planar inverted F-antenna positioned on the dielectric substrate.

13. A mobile station having an antenna assembly, wherein the antenna assembly comprises:
a quarter-wavelength slot antenna comprising:
a dielectric substrate having a first side, a second side and at least one edge;
an electrically conducting layer positioned on the first side of the dielectric substrate, wherein there is a rectangular slot in the electrically conducting layer exposing a portion of the first side of the dielectric substrate, and wherein a first side of the rectangular slot is aligned with the at least one edge of the dielectric substrate;
a feed line positioned on the second side of the dielectric substrate, wherein a centerline of the feed line extends parallel to the first side of the rectangular slot and wherein the feed line extends along the at least one edge of the dielectric substrate, and wherein the feed line has proximal and distal ends, the distal end of the feed line extending just into a region on the second side of the dielectric substrate directly opposite the rectangular slot; and
an L-shaped tuning stub positioned on the second side of the dielectric substrate directly opposite the rectangular slot of the first side, the L-shaped tuning stub comprising a first branch extending transversely from the distal end of the feed line away from the first edge of the dielectric substrate parallel to a second side of the rectangular slot, wherein the first branch has proximal and distal ends, the L-shaped tuning stub further comprising a second branch extending transversely from the distal end of the first branch parallel to the first side of the rectangular slot.

14. The mobile station of claim 13, wherein the quarter-wavelength slot antenna operates in the frequency range of about 3.1 GHz to 4.9 GHz.

15. The mobile station of claim 13, wherein the antenna assembly further comprises a dual-band planar inverted F-antenna.

16. A mobile station having an antenna assembly, wherein the antenna assembly comprises:
a half-wavelength slot antenna comprising:
a dielectric substrate having a first side and a second side;
an electrically conducting layer positioned on the first side of the dielectric substrate, wherein there is a rectangular slot in the electrically conducting layer exposing a portion of the first side of the dielectric substrate, and wherein the rectangular slot has at least a first side and a second side orthogonal to the first side;
a feed line positioned on the second side of the dielectric substrate, wherein a centerline of the feed line extends parallel to the first side of the rectangular slot and wherein the feed line has proximal and distal ends, the distal end of the feed line extending just into a region on the second side of the dielectric substrate directly opposite the rectangular slot, bisecting the second side of the rectangular slot;
a fork-shaped tuning stub positioned on the second side of the dielectric substrate directly opposite the rectangular slot of the first side, the fork-shaped tuning stub comprising a first branch extending transversely in either direction from the distal end of the feed line parallel to the second side of the rectangular slot, wherein the first branch has an intermediate point and two distal ends, the intermediate point of the first branch aligning with the distal end of the feed line, the fork-shaped tuning stub further comprising second branches extending transversely from the distal end of the first branch parallel to the first side of the rectangular slot; and wherein
the first side of the rectangular slot is about 10 mm and the second side of the rectangular slot is about 28 mm; the first branch has a length of about 18 mm, and wherein the half-wavelength antenna operates in the frequency range of about 3.1 GHz to 4.9 GHz.

17. The mobile station of claim 16, wherein the antenna assembly further comprises a dual-band planar inverted F-antenna.
